(19) United States
(12) Patent Application Publication
(10) Pub. No.: US 2013/0189072 A1
(43) Pub. Date: Jul. 25, 2013

(54) SPRING SYSTEM TO REDUCE TURBOCHARGER WASTEGATE RATTLE NOISE

(71) Applicant: Robert Andrew Wade, Dearborn, MI (US)

(72) Inventor: Robert Andrew Wade, Dearborn, MI (US)

(73) Assignee: FORD GLOBAL TECHNOLOGIES, LLC, Dearborn, MI (US)

(21) Appl. No.: 13/356,849

(22) Filed: Jan. 24, 2012

(51) Int. Cl. F02B 37/18

(52) U.S. Cl. 415/1; 415/144

(57) ABSTRACT

A turbocharger for a motor vehicle. The turbocharger includes a compressor mechanically coupled to a turbine. The wastegate of the turbine includes a valve head matched to a valve seat. The valve head is retained at one end of an actuator arm. A resilient spacer is arranged between the valve head and the actuator arm. The resilient spacer is configured to forcibly separate the valve head from the actuator arm when the valve head is unseated.

### TECHNICAL FIELD

This application relates to the field of motor-vehicle engineering, and more particularly, to reducing noise emissions from a turbocharger.

### BACKGROUND AND SUMMARY

A turbocharger system for a motor vehicle may include a compressor and a turbine, with a wastegate selectively coupling the turbine inlet to the outlet. The wastegate may be opened to reduce boost pressure. In modern engine-control strategies, the wastegate may be held open at partial-load conditions to reduce engine backpressure. The lower backpressure reduces pumping work and thereby improves fuel economy when high boost is not required.

A state-of-the-art turbocharger wastegate includes a linkage of movable parts that span an extraordinary range of temperatures—e.g., from 1050° C. at the valve head to ambient temperature at the actuator. Accordingly, the linkage must be heat-resistant and allow for thermal expansion and part wear over time. Some wastegate solutions include exotic, high-temperature materials and multiple, high-clearance connections. However, the high clearances used for expansion tolerance may also allow vibration, leading to unwanted impact noise as the various parts in the linkage collide with each other.

Accordingly, one embodiment of this disclosure provides a turbocharger for a motor vehicle. The turbocharger includes a compressor mechanically coupled to a turbine. The wastegate of the turbine includes a valve head matched to a valve seat. The valve head is retained at one end of an actuator arm. A resilient spacer is arranged between the valve head and the actuator arm. The resilient spacer is configured to forcibly separate the valve head from the actuator arm when the valve head is unseated. In this manner, noise-causing impact of the valve head on the actuator arm is reduced, even in cases where a relatively large thermal-expansion gap is provided between the valve head and actuator arm.

The summary above is provided to introduce a selected part of this disclosure in simplified form, not to identify key or essential features. The claimed subject matter, defined by the claims, is limited neither to the content of this summary nor to implementations that address problems or disadvantages noted herein.

### BRIEF DESCRIPTION OF THE DRAWINGS

FIGS. 1 and 2 schematically show aspects of engine systems in accordance with embodiments of this disclosure.

FIG. 3 schematically shows aspects of a turbocharger in accordance with an embodiment of this disclosure.

FIG. 4 is a perspective view of a turbocharger in accordance with an embodiment of this disclosure.

FIGS. 5 through 8 schematically show aspects of turbocharger wastegates in accordance with embodiments of this disclosure.

FIG. 9 illustrates an example method for operating a motor vehicle equipped with a turbocharger wastegate in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. Except where particularly noted, the drawing figures included in this disclosure are schematic and generally not drawn to scale. Rather, the various drawing scales, aspect ratios, and numbers of components shown in the figures may be purposely distorted to make certain features or relationships easier to see.

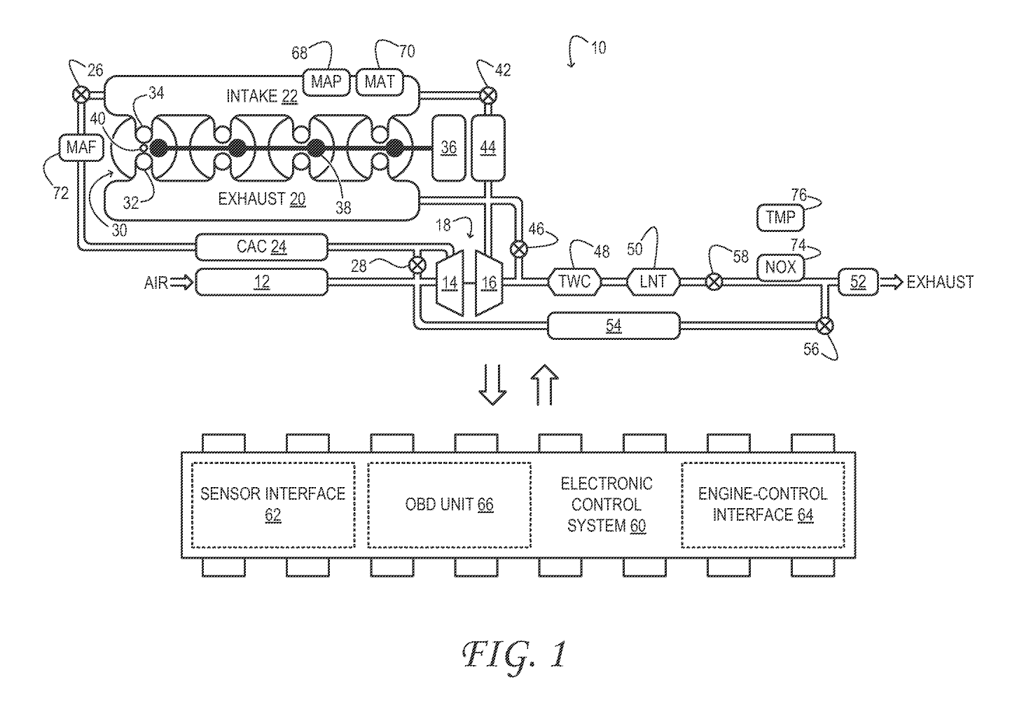

FIG. 1 schematically shows aspects of an example engine system 10 of a motor vehicle. In the illustrated engine system, fresh air is inducted into air cleaner 12 and flows to compressor 14. In the illustrated embodiment, the compressor is mechanically coupled to turbine 16 in turbocharger 18, the turbine driven by expanding engine exhaust from exhaust manifold 20.

Compressor 14 is coupled fluidically to intake manifold 22 via charge-air cooler (CAC) 24 and throttle valve 26. Pressurized air from the compressor flows through the CAC and the throttle valve en route to the intake manifold. In the illustrated embodiment, compressor by-pass valve 28 is coupled between the inlet and the outlet of the compressor. The compressor by-pass valve may be a normally closed valve configured to open to relieve excess boost pressure under selected operating conditions.

Exhaust manifold 20 and intake manifold 22 are coupled to a series of cylinders 30 through a series of exhaust valves 32 and intake valves 34, respectively. In one embodiment, the exhaust and/or intake valves may be electronically actuated. In another embodiment, the exhaust and/or intake valves may be cam actuated. Whether electronically actuated or cam actuated, the timing of exhaust and intake valve opening and closure may be adjusted as needed for desired combustion and emissions-control performance.

Cylinders 30 may be supplied any of a variety of fuels: gasoline, alcohols, or mixtures thereof. In the illustrated embodiment, fuel from fuel pump 36 is supplied to the cylinders via direct injection through fuel injectors 38. In the various embodiments considered herein, the fuel may be supplied via direct injection, port injection, throttle-body injection, or any combination thereof. In engine system 10, combustion is initiated via spark ignition at spark plugs 40. The spark plugs are driven by timed high-voltage pulses from an electronic ignition unit (not shown in the drawings).

Engine system 10 includes high-pressure (HP) exhaust-gas recirculation (EGR) valve 42 and HP EGR cooler 44. When the HP EGR valve is opened, some high-pressure exhaust from exhaust manifold 20 is drawn through the HP EGR cooler to intake manifold 22. In the intake manifold, the high pressure exhaust dilutes the intake-air charge for cooler combustion temperatures, decreased emissions, and other benefits. The remaining exhaust flows to turbine 16 to drive the turbine. When reduced turbine torque is desired, some or all of the exhaust may be directed instead through wastegate 46, by-passing the turbine. The combined flow from the turbine and the wastegate then flows through the various exhaust-aftertreatment devices of the engine system, as further described below.

In gasoline engine system 10, three-way catalyst (TWC) stage 48 is coupled downstream of turbine 16. The TWC stage includes an internal catalyst-support structure to which a catalytic washcoat is applied. The washcoat is configured to oxidize residual CO, hydrogen, and hydrocarbons and to reduce nitrogen oxides (NOₓ) present in the engine exhaust. In a lean-burn gasoline or diesel engine system (further described below), lean NOₓ trap (LNT) 50 is coupled downstream of TWC stage 48. The LNT is configured to trap NOₓ from the exhaust flow when the exhaust flow is lean, and to reduce the trapped NOₓ when the exhaust flow is rich.

The nature, number, and arrangement of exhaust-aftertreatment stages in the engine system may differ for the different embodiments of this disclosure. For instance, a soot filter may be included in some configurations. Other embodiments may include a multi-purpose exhaust-aftertreatment stage that combines filtering with other emissions-control functions, such as NOₓ trapping.

Continuing in FIG. 1, all or part of the treated exhaust may be released into the ambient via silencer 52. Depending on operating conditions, however, some treated exhaust may be diverted through low-pressure (LP) EGR cooler 54. The exhaust may be diverted by opening LP EGR valve 56 coupled in series with the LP EGR cooler. From LP EGR cooler 54, the cooled exhaust gas flows to compressor 14. By partially closing exhaust-backpressure valve 58, the flow potential for LP EGR may be increased during selected operating conditions. Other configurations may include a throttle valve upstream of air cleaner 12 instead of the exhaust back-pressure valve.

Engine system 10 includes electronic control system 60 configured to control various engine-system functions. The electronic control system includes memory and one or more processors configured for appropriate decision making responsive to sensor input and directed to intelligent control of engine-system componentry. Such decision-making may be enacted according to various strategies such as event-driven, interrupt-driven, multi-tasking, multi-threading, and the like. In this manner, the electronic control system may be configured to enact any or all aspects of the methods disclosed hereinafter. Accordingly, the method steps disclosed hereinafter—e.g., operations, functions, and/or acts—may be embodied as code programmed into machine-readable storage media in the electronic control system.

Electronic control system 60 includes sensor interface 62, engine-control interface 64, and on-board diagnostic (OBD) unit 66. To assess operating conditions of engine system 10 and of the vehicle in which the engine system is installed, sensor interface 62 receives input from various sensors arranged in the vehicle—flow sensors, temperature sensors, pedal-position sensors, pressure sensors, etc. Some example sensors are shown in FIG. 1—manifold air-pressure (MAP) sensor 68, manifold air-temperature sensor (MAT) 70, mass air-flow (MAF) sensor 72, NOₓ sensor 74, and exhaust-system temperature sensor 76. Various other sensors may be provided as well.

Electronic control system 60 also includes engine-control interface 64. The engine-control interface is configured to actuate electronically controllable valves, actuators, and other componentry of the vehicle—throttle valve 26, compressor by-pass valve 28, wastegate 46, and EGR valves 42 and 56, for example. The engine-control interface is operatively coupled to each electronically controlled valve and actuator and is configured to command its opening, closure, and/or adjustment as needed to enact the control functions described herein.

Electronic control system 60 also includes on-board diagnostic (OBD) unit 66. The OBD unit is a portion of the electronic control system configured to diagnose degradation of various components of engine system 10. Such components may include oxygen sensors, fuel injectors, and emissions-control components, as examples.

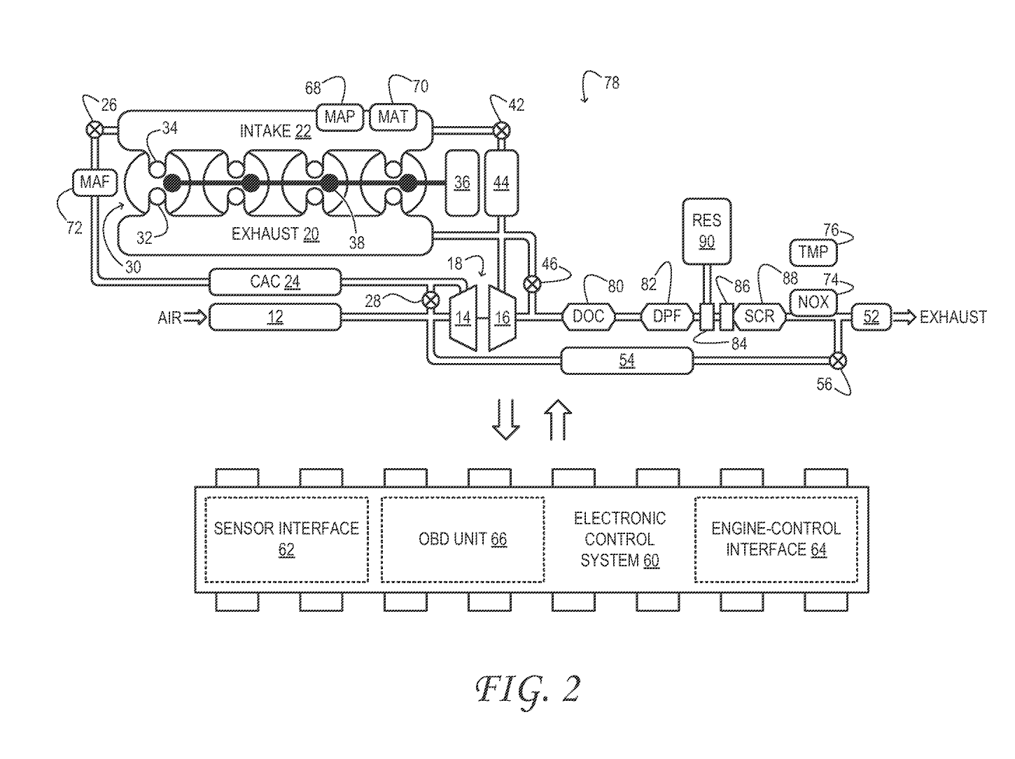

FIG. 2 shows aspects of another engine system 78—a diesel engine in which combustion is initiated via compression ignition. Accordingly, cylinders 30 of engine system 78 are supplied diesel fuel, biodiesel, etc., from fuel-pump 36.

In engine system 78, diesel-oxidation catalyst (DOC) 80 is coupled downstream of turbine 16. The DOC includes an internal catalyst-support structure to which a DOC washcoat is applied. The DOC is configured to oxidize residual CO, hydrogen, and hydrocarbons present in the engine exhaust.

Diesel particulate filter (DPF) 82 is coupled downstream of DOC 80. The DPF is a regenerable soot filter configured to trap soot entrained in the engine exhaust flow; it comprises a soot-filtering substrate. Applied to the substrate is a washcoat that promotes oxidation of the accumulated soot and recovery of filter capacity under certain conditions. In one embodiment, the accumulated soot may be subject to intermittent oxidizing conditions in which engine function is adjusted to temporarily provide higher-temperature exhaust. In another embodiment, the accumulated soot may be oxidized continuously or quasi-continuously during normal operating conditions.

Reductant injector 84, reductant mixer 86, and SCR stage 88 are coupled downstream of DPF 82 in engine system 78. The reductant injector is configured to receive a reductant (e.g., a urea solution) from reductant reservoir 90 and to controllably inject the reductant into the exhaust flow. The reductant injector may include a nozzle that disperses the reductant solution in the form of an aerosol. Arranged downstream of the reductant injector, the reductant mixer is configured to increase the extent and/or homogeneity of the dispersion of the injected reductant in the exhaust flow. The reductant mixer may include one or more vanes configured to swirl the exhaust flow and entrained reductant to improve the dispersion. Upon being dispersed in the hot engine exhaust, at least some of the injected reductant may decompose. In embodiments where the reductant is a urea solution, the reductant will decompose into water, ammonia, and carbon dioxide. The remaining urea decomposes on impact with the SCR stage (vide infra).

SCR stage 88 is coupled downstream of reductant mixer 86. The SCR stage may be configured to facilitate one or more chemical reactions between ammonia formed by the decomposition of the injected reductant and NOₓ from the engine exhaust, thereby reducing the amount of NOₓ released into the ambient. The SCR stage comprises an internal catalyst-support structure to which an SCR washcoat is applied. The SCR washcoat is configured to sorb the NOₓ and the ammonia, and to catalyze the redox reaction of the same to form dinitrogen (N₂) and water.

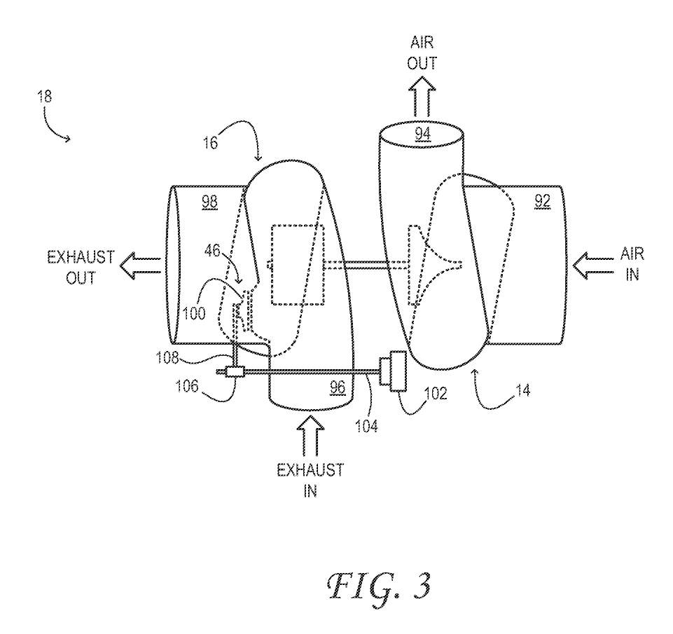

FIG. 3 schematically shows aspects of an example turbocharger 18 in one embodiment. The turbocharger includes compressor 14 with fresh air inlet 92 and compressed air outlet 94. The compressor is mechanically coupled to turbine 16, which includes exhaust inlet 96 and exhaust outlet 98. In turbine 16, wastegate 46 selectably links the exhaust inlet to the exhaust outlet. The wastegate includes valve head 100 actuated by pneumatic actuator 102 via a mechanical linkage. The mechanical linkage includes external shaft 104, external arm 106, thru-shaft 108, and other components further described below. Electronic control system 110 is configured to provide appropriate electronic drive signals to the pneumatic actuator to fully open and close the wastegate. In some embodiments, the pneumatic actuator may also be configured to position the wastegate in one or more partially open states.

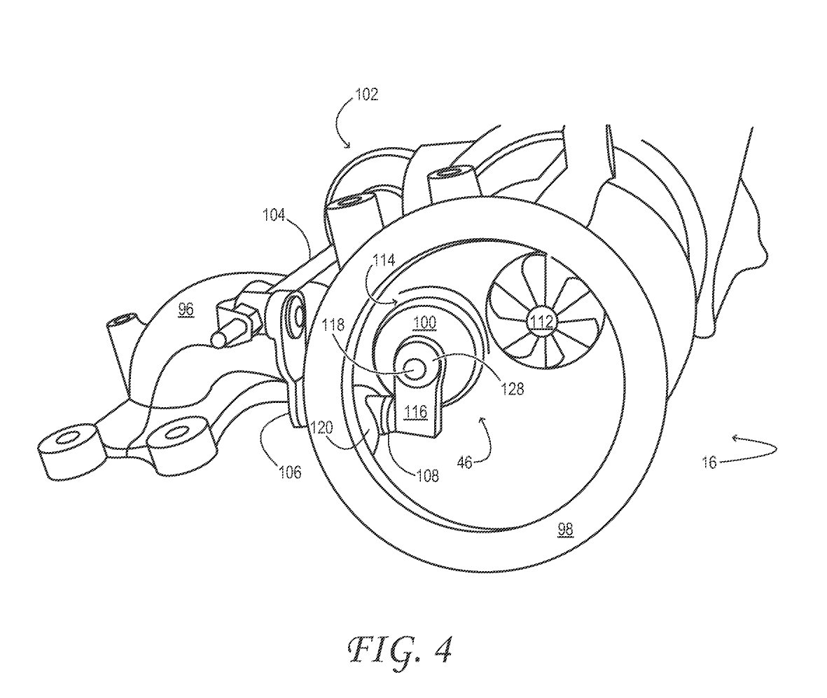

FIG. 4 is a perspective view of turbocharger 18 as observed from exhaust outlet 98. This view shows wastegate 46 fluidically downstream of turbine wheel 112. FIG. 4 is a scale drawing of one, non-limiting embodiment, but also represents other embodiments in which some aspects may differ in scale or structure.

FIG. 4 shows valve head 100 matched to valve seat 114. The valve head is retained at one end of actuator arm 116. The valve head may be retained on the actuator arm by any suitable retaining member—e.g., pin 118 in the illustrated embodiment. In turbine 16, actuator arm 116 is linked to thru-shaft 108. The thru-shaft passes through exhaust outlet 98 through bushing 120, which permits rotation of the thru-shaft but prevents exhaust gas from escaping. Outside of exhaust outlet 98, the thru-shaft is coupled to external arm 106. The external arm is pivotally mounted to the exterior surface of the exhaust outlet; it pivots due to the push-pull action of pneumatic actuator 102, via external shaft 104. Through this linkage, the pneumatic actuator is mechanically coupled to the actuator arm.

To accommodate expansion due to large thermal gradients in exhaust outlet 98, the mechanical linkage described hereinabove may be designed with high-clearance connections between its members. For instance, pin 118 may be of such length as to provide an expansion gap of up to one millimeter, approximately, between valve head 100 and actuator arm 116. When the wastegate is closed, compressive force from valve seat 114 closes this gap, so that the valve head is flush against the actuator arm. When the wastegate is open, however, the gap may enable the valve head to vibrate on the end of the actuator arm, causing unwanted noise. This issue is all the more important in modern control strategies for turbocharged gasoline direct injected (GDI) engines. Here, the wastegate may be left open during partial-load conditions for increased fuel economy.

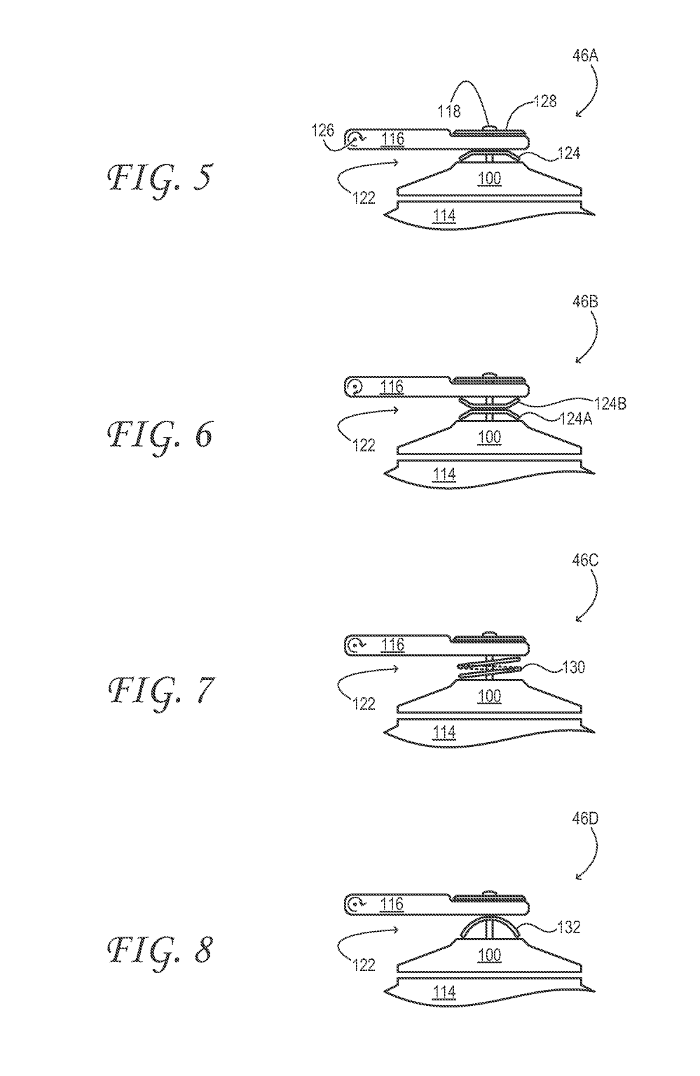

Accordingly, the wastegate configurations here described include a resilient spacer arranged in the expansion gap between valve head 100 and actuator arm 116. One example is shown in FIG. 5. This drawing shows aspects of a turbocharger wastegate 46A, including valve head 100 and valve seat 114, with expansion gap 122 arranged therebetween. The valve head is coupled to actuator arm 116 via resilient spacer 124.

A closure force applied through actuator arm 116 reversibly seats valve head 100 to valve seat 114. Resilient spacer 124 is compressible under such force, so that the valve head approaches the actuator arm when the valve head is seated. The resilient spacer is partially compressed (i.e., shorter than its natural length) even when the valve head is unseated and, in this state, maintains its restoring force between the valve head and the actuator arm. In this manner, the resilient spacer is configured to forcibly separate the valve head from the actuator arm when the valve head is unseated. The valve head is held in place by a reaction force of the retaining member—e.g., pin 118—on the valve head. The resilient spacer may be chosen advantageously, so that the restoring force is sufficient to press the valve head through the lash and retain it in that position. This eliminates the noise associated with the valve head moving through the lash. In other words, the restoring force of the spacer may be sufficient, in the unseated, partially compressed state, to silence a vibration of the valve head against the actuator arm during operation of the motor vehicle. Noise-causing impact of the valve head on the actuator arm is reduced, therefore, even in cases where a relatively large thermal-expansion gap is provided between the valve head and actuator arm.

The resilient spacer is compressed to a greater degree when the valve head is seated. In this state, it maintains a greater restoring force between the valve head and the actuator arm, which acts to separate these components. In some embodiments, the resilient spacer may obey Hooke's Law; it may exhibit a spring constant on the order of 10⁴ to 105 pounds per inch of compression, for example.

In the embodiments illustrated herein, the force applied through the actuator arm is a torsional force about pivot point 126 of the actuator arm. It will be noted, however, that this disclosure is entirely consistent with configurations in which the applied force is linear instead of torsional.

In the embodiment of FIG. 5, the retaining member is pin 118 with flat washer 128 inserted between head of the pin and the actuator arm. In this embodiment, resilient spacer 124 surrounds the retaining member. In some embodiments, the resilient spacer may include a spring of one kind or another. In the embodiment of FIG. 5, the resilient spacer is a Belleville washer, also known as a coned-disc spring, a conical spring washer, a disc spring, a Belleville spring, or a cupped spring washer. In one embodiment, the Belleville washer may have a puckered or frusto-conical shape. Like other resilient spacers disclosed herein, the Belleville washer may be made of steel or any other resilient, heat-resistant material.

FIG. 6 shows aspects of another turbocharger wastegate 46B with another resilient spacer. In this embodiment, the resilient spacer includes a back-to-back pair of Belleville washers 124A and 124B. More generally, the resilient spacer may include two or more resilient members arranged in series—viz., front-to-back, back-to-back, or back-to front. FIG. 7 shows aspects of another turbocharger wastegate 46C with another resilient spacer. In this embodiment, the resilient spacer is coil spring 130. FIG. 8 shows aspects of another turbocharger wastegate 46D with yet another resilient spacer. In this embodiment, the resilient spacer is leaf spring 132.

No aspect of the foregoing drawings is intended to be limiting, as numerous variations are contemplated as well. For instance, Belleville washer 124 may be slotted in some examples to reduce the spring constant. In other examples, leaf spring 132 may be a layered leaf spring. Each unique configuration may provide advantages for managing the dynamic response of the system.

The configurations described above enable various methods for operating a turbocharged motor vehicle. Some such methods are now described, by way of example, with continued reference to the above configurations. It will be understood, however, that the methods here described, and others within the scope of this disclosure, may be enabled by different configurations as well. The methods may be entered upon any time an engine system is operating, and may be executed repeatedly. Naturally, each execution of a method may change the entry conditions for subsequent execution and thereby invoke a complex decision-making logic. Such logic is fully contemplated in this disclosure.

Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

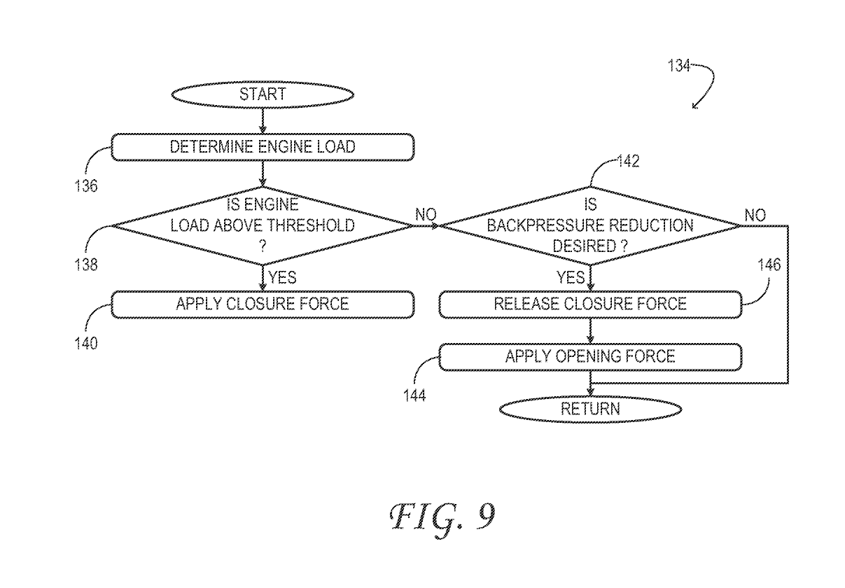

FIG. 9 illustrates an example method 134 for operating a motor vehicle equipped with a turbocharger wastegate as described hereinabove. At 136 of the method, the engine load is determined. The engine load may be determined directly or indirectly—e.g., via a surrogate metric such as the MAP. At 138 it is determined whether the engine load is above a threshold. In one embodiment, the engine-load threshold may be set to high-load conditions where maximum boost is desired. If the engine load is above the threshold, then the method advances to 140. At 140, a closure force is applied to the wastegate actuator arm of the turbocharger to seat the valve head on the valve seat. The closure force may be sufficient to compress the resilient spacer of the wastegate such that the valve head approaches the actuator arm. The closure force may be greater than a restoring force of the resilient spacer at least when the valve head and actuator arm are a maximum distance apart.

Continuing in FIG. 9, if the engine load is not above the threshold, then the method advances to 142. At 142 it is determined whether a reduction in engine backpressure is desired. A reduction in backpressure may be desired, for example, during so-called partial-load conditions, where maximum boost is not required. If backpressure reduction is desired, then the method advances to 144 and then to 146. At 144, the closure force on the actuator arm is released, thereby expanding the resilient spacer such that the valve head separates from the actuator arm. At 146, an opening force is applied to the actuator arm as the closure force is released. The opening force may be directed opposite the closure force. In one embodiment, both the closure force and the opening force may be torsional forces.

In a more particular embodiment, the closure force and the opening force may be applied by a pneumatic actuator driven by an electronic control system of the motor vehicle. The electronic control system may provide suitable drive signals to cause the pneumatic actuator to enact the methods here described.

It will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A turbocharger for a motor vehicle, comprising:
a turbine having a wastegate with a valve head matched to a valve seat, the valve head retained at one end of an actuator arm, a resilient spacer arranged between the valve head and the actuator arm and configured to forcibly separate the valve head from the actuator arm when the valve head is unseated; and
a compressor mechanically coupled to the turbine.

2. The turbocharger of claim 1 wherein a force applied through the actuator arm reversibly seats the valve head to the valve seat, and wherein the resilient spacer is compressible under such force, so that the valve head approaches the actuator arm when the valve head is seated.

3. The turbocharger of claim 2 wherein the force is a torsional force applied at a pivot point of the actuator arm.

4. The turbocharger of claim 1 wherein the valve head is retained on the actuator arm by a retaining member.

5. The turbocharger of claim 4 wherein the retaining member includes a pin.

6. The turbocharger of claim 4 wherein the resilient spacer surrounds the retaining member.

7. The turbocharger of claim 4 wherein the resilient spacer, partly compressed when the valve head is unseated, applies a restoring force between the valve head and the actuator arm, and wherein the valve head is held in place by a reaction force of the retaining member on the valve head.

8. The turbocharger of claim 7 wherein the restoring force is sufficient to silence a vibration of the valve head against the actuator arm during operation of the motor vehicle.

9. The turbocharger of claim 1 wherein the resilient spacer includes a spring.

10. The turbocharger of claim 1 wherein the resilient spacer includes a Belleville washer.

11. The turbocharger of claim 1 wherein the resilient spacer includes a coil spring.

12. The turbocharger of claim 1 wherein the resilient spacer includes a leaf spring.

13. The turbocharger of claim 1 wherein the resilient spacer includes two or more resilient members.

14. The turbocharger of claim 1 wherein the two or more resilient members are arranged in series.

15. A method for operating a motor vehicle equipped with a turbocharger, the turbocharger including a compressor mechanically coupled to a turbine, the turbine having a wastegate with a valve head matched to a valve seat, the valve head retained at one end of an actuator arm, a resilient spacer arranged between the valve head and the actuator arm, the method comprising:
applying a closure force to the actuator arm to seat the valve head on the valve seat, the closure force being sufficient to compress the resilient spacer such that the valve head approaches the actuator arm; and
releasing the closure force to expand the resilient spacer such that the valve head separates from the actuator arm.

16. The method of claim 15 wherein the closure force is greater than a restoring force of the resilient spacer at least when the valve head and actuator arm are a maximum distance apart.

17. The method of claim 15 further comprising applying an opening force to the actuator arm when releasing the closure force, the opening force directed opposite the closure force.

18. The method of claim 15 wherein the closure force is a torsional force.

19. A system for a motor vehicle, comprising:
a turbocharger including a compressor mechanically coupled to a turbine, the turbine having a wastegate with a valve head matched to a valve seat, the valve head retained at one end of an actuator arm, an expansion gap arranged between the valve head and the actuator arm;
a resilient spacer arranged in the expansion gap in contact with the valve head and the actuator arm, the spacer being partially compressed when the valve head is unseated and maintaining a first force of separation between the valve head and the actuator arm, the spacer being more compressed when the valve head is seated and maintaining a second, greater force of separation between the valve head and the actuator arm;
a pneumatic actuator mechanically coupled to the actuator arm; and
an electronic control system configured to drive the pneumatic actuator.

20. The system of claim 19 wherein the electronic control system provides a drive signal to cause the pneumatic actuator to:
apply a closure force to the actuator arm to seat the valve head on the valve seat, the closure force being sufficient to compress the resilient spacer such that the valve head approaches the actuator arm; and
release the closure force to expand the resilient spacer such that the valve head separates from the actuator arm.
